(19) United States
(12) Patent Application Publication
(10) Pub. No.: US 2003/0170908 A1
(43) Pub. Date: Sep. 11, 2003

(54) Method for making microsensor arrays for detecting analytes

(76) Inventors: Frank V. Bright, Williamsville, NY (US); Eun Jeong Cho, Austin, TX (US)

Correspondence Address: Glenn D. Smith, Hodgson Russ LLP, Suite 2000, One M&T Plaza, Buffalo, NY, 14203-2391, US

(21) Appl. No.: 10/351,109

(22) Filed: Jan. 24, 2003

Related U.S. Application Data
(63) Continuation-in-part of application No. 10/254,254, filed on Sep. 25, 2002, now Pat. No. 6,589,438.
Application No. 10/254,254 is a division of application No. 09/628,209, filed on Jul. 28, 2000, now Pat. No. 6,492,182.
(60) Provisional application No. 60/351,592, filed on Jan. 25, 2002.

(51) Int. Cl. G01N 24/00

(52) U.S. Cl. 436/173

(57) ABSTRACT

The present invention provides a method of producing an electromagnetic radiation-based sensor device. The method comprises pin printing one or more chemical sensing materials onto a substrate so as to form a sensor device.

This application is a continuation-in-part application of U.S. patent application Ser. No. 10/254,254 filed Sep. 25, 20002; which is a divisional application of U.S. application Ser. No. 09/628,209 filed Jul. 28, 2000, now U.S. Pat. No. 6,492,182. This application also claims the priority of U.S. Provisional Application Serial No. 60/351,592 filed on Jan. 25, 2002. The disclosure of each of these applications is incorporated herein by reference.

This invention was made with Government support under Grant Number CHE0078161 awarded by the National Science Foundation. The Government has certain rights in the invention.

### BACKGROUND OF THE INVENTION

1. Field of the Invention

The present invention relates to the field of reusable multianalyte chemical sensor arrays. More particularly, the present invention provides a method to rapidly produce reusable multianalyte chemical sensor arrays.

2. Description of the Related Art

Chemical sensors are widely used in clinical diagnosis and biomedical research to selectively detect the presence of a particular analyte or ensemble of analytes, or to measure other characteristics of samples, such as pH. These measurements are based on the principle that interaction of a chemical sensor with an analyte within a sample results in modification of spectroscopic properties of the sensor to a degree that depends on the concentration of the analyte. The modification of spectroscopic properties may involve changes in the intensity, wavelength, phase, or polarization of the incident electromagnetic radiation. For example, fluorophores are molecules that absorb light at certain wavelengths and emit light of a different wavelength (generally longer). In the presence of an analyte, the optical properties of some fluorophores are altered and this forms the basis for optical detection and quantitation of analytes using fluorophores.

Chemically responsive sensor arrays can be subdivided into those that use cantilevers, conducting polymers, electrochemistry, the piezoelectric effect, physical optics, or surface acoustic waves. To date, sensor arrays have been fabricated by using a number of approaches including, ink-jet and screen printing, photolithography, and photodeposition.

Over the past several years, DNA-chip technologies have driven the development of high-speed printing techniques, such as pin printing, for genomic research and diagnostics. Pin printing methods have yet to be used to fabricate reusable multi-analyte chemical sensor arrays.

### SUMMARY OF THE INVENTION

The present invention provides a method of producing an electromagnetic radiation (ER)—based sensor device. The method is simple and more rapid than existing methods. The chemical sensor is pin printed onto the substrate using one or more chemical sensing materials so as to form a sensor device. While any substrate transparent or translucent to ER may be used in the method of the present invention, in a preferred embodiment of the invention the method uses an ER generator as a substrate for the sensor device. In yet another preferred embodiment, the ER generator is a modified LED (light emitting diode).

Thus, an object of the present invention is to provide a rapid and efficient method of making a sensor array device.

A further object of the invention is to provide a rapid and efficient method of making an integrated ER generating base/sensor array device.

A sensor array device prepared according to the present invention comprises an ER transparent or translucent substrate having a chemical sensor for interacting selectively with a particular analyte in a sample. In the absence of the analyte, the chemical sensor displays certain baseline spectroscopic properties characteristic of the sensor. However, when the analyte is present in the sample, the spectroscopic properties of the chemical sensor are modified.

Detection and quantitation of the analyte are based on a comparison of the modified properties and the baseline properties and the use of standard calibration methods that are well known to those skilled in the art of analytical chemistry.

### BRIEF DESCRIPTION OF THE DRAWINGS

FIG. 1 is a schematic representation of exemplary contact printing dispensers.

FIG. 2 is a schematic representation of a general configuration for detecting the electromagnetic radiation emitted by a chemical sensor prepared according to the invention herein.

FIG. 3 is a schematic representation of the processes for forming PPOSAILS type chemical sensor arrays.

FIG. 4 is a simplified schematic representation of forming four types of biosensor arrays.

FIG. 5 summarizes the response characteristics from a typical PPCSA prepared according to Example 3.

FIG. 6 is a composite calibration curve of the pH-responsive PPCSAs prepared according to Example 3.

FIGS. 7 A-D summarizes the response from randomly selected O₂ and pH sensor elements within a dual analyte PPCSA prepared according to Example 3.

FIG. 8 summarizes the response characteristics from a typical X-type PPOSAILS prepared according to Example 5.

FIG. 9 summarizes the response characteristics from a typical P-type PPOSAILS prepared according to Example 5.

### DETAILED DESCRIPTION OF THE PREFERRED EMBODIMENTS

The expression “pin printing” as used herein means a method using one or more pin tools to contact print/spot liquid onto a planar surface (e.g., a microscope slide).

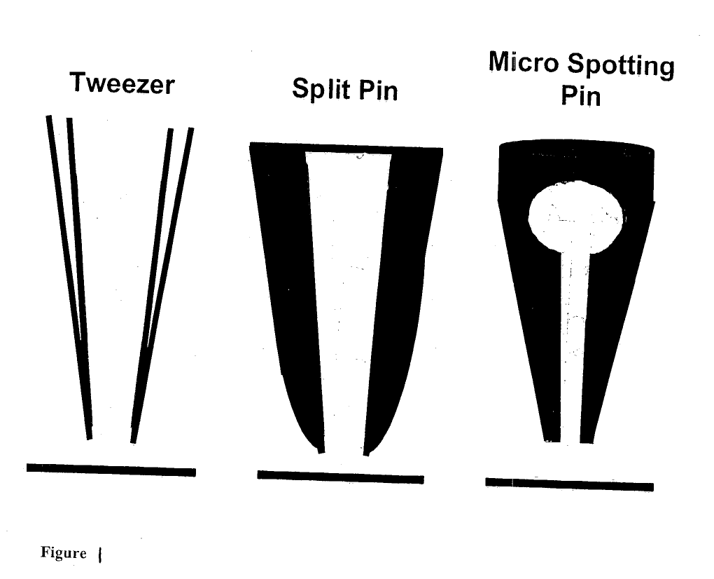

The term “pin” as utilized herein refers to any of a variety of contact printing dispensers, i.e. pin tools, known to those skilled in the art and includes solid pins, printing capillaries, tweezers, split pins, etc. The pin may be made of metal or any other suitable material. Examples of pins can be found in FIG. 1. The selection of a particular pin is within the purview of one skilled in the art.

The term “chemical sensor” or “chemical sensors” as used herein means a molecule or molecules that detect(s) the presence of an analyte. The chemical sensor comprises a sensor element whose optical properties are modified in the presence of an analyte. The properties of the sensor element may be directly modified upon its interaction with the analyte. Alternatively, the sensor element may be attached to a molecule having a specific affinity for the analyte, in which case, the optical properties of the sensor element are modified upon the interaction of the affinity molecule with the analyte. Thus, by the term “spectroscopic properties of the chemical sensor” or “chemical sensor's spectroscopic properties” is meant the spectroscopic properties of the sensor element and vice versa. These properties may be optical in nature when the emitted electromagnetic radiation is within the visible spectrum i.e., between about 400 nm to about 800 nm. As an example if the chemical sensor is a fluorescein tagged antibody, the sensor element is fluorescein and the affinity molecule is the antibody. In another example, where the chemical sensor is a luminescent ruthenium dye ([Ru(dpp)₃]²⁺), the sensor element and the chemical sensor are the same.

The expression “pin printed chemical sensor array” (PPCSA) as utilized herein means a sensor element array device contact printed onto a planar substrate in an array pattern wherein the sensor element array is excited with an external light source.

The expression “pin printed optical sensor array and integrated light source” (PPOSAILS) as utilized herein means a sensor element array device contact printed onto an ER generating substrate such as the face of an LED.

The expression “pin printed biosensor arrays” (PPBSA) as utilized herein means an immobilized biomolecule sensor element array device contact printed onto a planar substrate. The PPBSA may also be used along with other chemical sensors in a PPCSA or a PPOSAILS sensor array device.

The present invention provides a method of rapidly and efficiently making a reusable multianalyte chemical sensor element array device. In addition, another embodiment of the present invention provides a method of rapidly and efficiently making a compact and energy efficient ER generating sensor array device. A device prepared according to the invention herein can be used for the simultaneous detection and quantification of one or more analytes in a sample. The device comprises a substrate transparent or translucent to ER. Examples of suitable substrates for use in certain embodiments of the invention herein would include glass microscope slides, polymeric microscope slides, polymeric coated glass microscope slides, cover slips for microscope slides, optical filters, mirrored slides, optical array detectors (e.g., charge coupled device detectors). In certain embodiments the substrate is an ER generator. The ER generated by the generator is such that at least some of it can be absorbed by a phosphore, fluorophore, and/or chromophore of the chemical sensor. To be absorbed by the luminophore (fluorophore or phosphore) or chromophore requires that the wavelength range output from the generator overlap at least partially with one or more allowed electronic transitions within the chemical sensor or sensor element. Typically the electromagnetic radiation capable of exciting and/or populating upper electronic transitions in a substance fall within a wavelength region of 200 nm to 900 nm and thus includes, ultraviolet, visible and infrared portions of the electromagnetic spectrum.

The ER generator can be any means for generating electromagnetic radiation of a wavelength that will cause electronic transitions in a chemical sensor such as light emitting diodes, diode lasers and micro discharge devices such as those disclosed in U.S. Pat. Nos. 6,016,027, 6,139,384 and 6,194,833. In a preferred embodiment, the electromagnetic radiation generator is a light emitting diode (LED). When an LED is used as the ER generating substrate it can be an LED that is formed with a planar surface or may be an LED that has been machined to remove a portion of its protective envelope to provide a planar surface. Depending upon the composition of the substrate, it may be necessary to apply a buffer layer to the substrate prior to beginning pin printing. Any suitable material that is at least translucent may be used as the buffer layer. A suitable material for forming the buffer layer will be one that is able to adhere to the substrate and allows the sensor elements to adhere to it. Examples of suitable materials for forming a buffer layer would include sol-gel solutions, pigmented sol-gel solutions, tinted sol-gel solutions, paint, polymers, et cetera. When the substrate is a machined LED or some other substrate with an irregular surface, it may be necessary to form a buffer layer to provide a uniform surface prior to pin printing. When the substrate is a uniform surface and adhesion of the sensor element to the substrate is adequate, it may not be necessary to use a buffer layer. In applications where it is desirable to limit the wavelength of light reaching the sensor element, the buffer layer may comprise a filtering coating selected to be transmissive for the peak wavelength of the ER generating substrate. Buffer layers may be applied to the substrate by any suitable method, for example, spraying, coating, spin-coating, casting, vapor deposition, et cetera.

The sensor element can be placed directly on the substrate. The number, size, and shape of the sensor element placed on a substrate can vary. While any ratio of sensor element area to non sensor element area is suitable, a ratio of 1:1 generally ensures that individual sensor elements are reasonably well separated from one another. For example, on an LED of 5 mm diameter, having 100 μm diameter sensor elements, with a 1:1 ratio of sensor element area to non sensor element area, it is estimated that 1200 discrete sensor elements can be formed on the LED face. Each sensor element may contain the same or different chemical sensor so that the same LED may be used for the simultaneous detection and quantitation of a single or multiple analytes.

To form the sensor element, a holding material is preferably used. Any liquid material known to those skilled in the art for holding, immobilizing, entrapping, and/or sequestering chemical sensors, can be used. These materials include, but are not limited to, sol-gel precursors, xerogels, aerogels, protein-doped xerogels, acrylamide gels, organic polymers, inorganic polymers, molecularly imprinted materials, and mixtures thereof. One commonly used holding material is a sol-gel-derived glass. A sol-gel-derived glass is a porous glass formed by the condensation and polycondensation of one or more metal or semi-metal alkoxide mixtures. Sol-gel-derived glasses provide a convenient means to sequester sensors, and/or sensing agents, because they prevent leaching from the holding material, and the glasses themselves are porous, thereby allowing analytes to penetrate into the glass, and react with the chemical sensors. Sol-gel processed xerogels are also useful for holding protein based chemical sensors. It is known that protein-doped xerogels demonstrate k_{cat,}kₘ or K_{binding} for biomolecules within the xerogels that are substantially unchanged from the values in solution and the xerogel-doped biomolecules remain stable for relatively long periods of time. It is also known that xerogels can be molecularly imprinted. Glasses with surface areas of up to several hundred square meters per gram and narrow pore diameters (0.5 to 500 nm)are readily prepared using sol-gel methods well known to those skilled in the art of sol-gel processing chemistry. A detailed discussion of sol-gel chemistry can be found in Reisfeld et al., 1992, Chemistry, Spectroscopy and Application of Sol-Gel glasses, Springer-Verlag, Berlin; Brinker et al., 1989, Sol-Gel Science, Academic Press, New York; Dave et al., 1994, Anal. Chem. 66:1120A, 1121A. It is preferred that the mean pore diameter be less than the mean wavelength of electromagnetic radiation from the generator, but deviation leads only to a predictable decrease in performance. The sol-gel-derived glass useful in the present invention is preferably transparent or translucent for wavelengths of from about 300 nm to about 900 nm. Translucent materials preferably have a transmittance of 50% or greater.

Chemical sensors may simply be added to the sol-gel-derived glass holding material once the sol-gel-derived glass is placed or located or formed on the substrate, or they may be doped into the sol-gel processing solution (precursor to the glass and/or xerogel) to provide a sensor element solution before it is placed onto the substrate. A property that makes sol-gel-processed materials useful for the present invention is that molecules sequestered within the glass may interact with diffusible analytes or components in an adjacent liquid or gas phase within the glass pore space. In addition to sol-gel-derived glass, other organic or inorganic polymers and mixtures thereof that can be pin printed onto the substrate and remain on the substrate, can also be used as holding materials.

Chemical sensors and/or sensor elements that are useful for the present invention include materials whose spectroscopic properties are modified due to interaction with specific analytes. The modification of spectroscopic properties may include a change in wavelength, intensity, phase, and/or polarization of the incident electromagnetic radiation.

Materials that are able to emit ER in the form of light as a result of—and only during—the absorption of light from another source are referred to as fluorophores or phosphores. The absorption and emission spectra are characteristic for each fluorophore or phosphore. Materials that absorb electromagnetic radiation and do not fluoresce generally convert any excess energy produced as a result of photoexcitation into heat energy or kinetic energy and are referred to as chromophores. Many dyes are known in the art that absorb electromagnetic radiation of a specific wavelength.

The detection of the transmitted or emitted electromagnetic radiation from the chemical sensor array device may be carried out by collecting the electromagnetic radiation from each individual chemical sensor with an objective, passing it through a filter system and ultimately communicating to a solid state array detector, such as a charge coupled device (CCD).

The substrate useful in the present invention is preferably transparent or translucent for at least some wavelengths of from about 300 nm to about 900 nm. Translucent substrate materials preferably have a transmittance of 50% or greater. Examples of substrate materials would include standard glass microscope slides such as those distributed by Fisher Laboratory Products of Pittsburgh, Pa. Polymeric substrates or polymeric coated substrates would also be suitable in the practice of the method described herein. Optionally, an optical filter can be used as a substrate. In a preferred embodiment of the invention herein ER generating substrates are used. An example of an ER generating substrate is an LED such as those distributed by Nichia America Corporation of Mountville, Pa. Preferred LEDs are machined to remove the domelike portion of the protective envelope to form a planer surface. Optionally, a LED formed without the rounded envelope may be used as the substrate.

Making a sensor array device according to the invention herein involves pin printing a small volume of chemical sensor and/or holding material onto the substrate. Methods of pin printing are well known by those skilled in the art. A description of suitable pin printing methods may be found in Mark Schena, ed., Microarray Biochip Technology Eaton Publishing, Westborough, Mass.

Pin printing involves direct contact between the printing mechanism and the substrate. Although pin printing may be performed manually, to obtain improved results, use is frequently made of electro-mechanical pin printing devices such as the ProSys 5510 System available from Cartesian Technologies, Inc. of Irving, Calif.

In pin printing, pin tools are dipped into the chemical sensor and/or holding material, resulting in the transfer of a small volume of fluid onto and/or within the tip of the pins. Pin tools deliver sample spots of chemical sensor and/or holding material onto the substrate and include solid pins, capillary tubes, tweezers, split pins and micro-spotting pins or “ink stamps”. Touching the pins or pin samples onto the substrate leaves a spot, the diameter of which is determined by the surface energies of the pin, fluid, and substrate; and the pin velocity. The pins typically have a loading volume of about 0.2 to about 0.6 μL and can produce spots ranging from about 600 to about 400 μm in diameter, depending on printing solution surface properties.

The final sensor element dimensions are a function of the pin's dimensions, the sol-gel-processing solution's composition, hydrolysis time, and mixing method (stirring vs. sonication), the relative humidity during printing, the pin contact time with the substrate, and substrate's surface chemistry. For example, individual xerogel-based sensor elements on the order of 100-150 μm in diameter and 1-2 μm in average thickness can be provided by certain embodiments of the invention herein. Selection of an appropriate final sensor element dimensions is within the purview of one skilled in the art.

Efficient cleaning of the pins during the printing process is recommendable to prevent solution carryover which would complicate any multianalyte sensing strategy. The pins may be cleaned by dipping the pins into ethanol or other suitable wash liquid and then removing the wash liquids from the pins with a vacuum. In cases where more rigorous cleaning is necessary, one can use dilute acid (e.g., HCl) or dilute base (e.g., NaOH) solutions.

The steps of pin-printing sensor array devices according to the invention herein may be summarized as follows:

1. Dip the pin into the chemical sensor and/or holding material and slowly withdraw.

2. optionally, move the pin to the pre-print slide and print several spots to get a uniform spot size by touching the pin to the surface.

3. Move the pin to the array substrate and print one or more spots, depending on the array.

4. Optionally, continue to print the substrates in the batch.

5. Dip the pin in wash solution(s).

6. Vacuum to remove wash solution(s).

7. Load next chemical sensor and/or holding material and repeat.

The above steps may be repeated any number of times either for applying chemical sensor and/or holding material to other regions of the substrate or to overprint a same region of the substrate with chemical sensor and/or holding material to provide a layered sensor element(s). Any number of layers as may be necessary to obtain a desired result may be over-printed onto a substrate to provide a layered sensor element.

The sensor array devices prepared by the method of the present invention comprise a chemical sensor whose optical properties are modified in the presence of an analyte. Chemical sensors that can be used for the present invention include electromagnetic radiation absorbing and electromagnetic radiation emitting inorganic or organic dyes (either natural, synthetic, or combinations thereof). Such dyes include phosphores, fluorophores, and chromophores. Many luminescent and chromogenic molecules are well known to those skilled in the art. Examples of such materials are disclosed in U.S. Pat. No. 5,250,264. Other sources of useful chemical sensors or sensor elements include the Handbook of Fluorescent Probes and Research Chemicals, 6th ed., authored by Richard P. Haugland and published by Molecular Probes, Inc. of Eugene, Oreg. As discussed above, some of the chemical sensor elements absorb light emitted from an LED or other light source in the presence of an analyte to a degree that depends on the analyte concentration, while others luminescence in the presence of the analyte to be detected and/or quantified to a degree that depends on the analyte concentration. Also as mentioned above, the chemical sensor element may directly detect the analyte or may indirectly detect the analyte through an affinity molecule. Such affinity molecules will have substantial affinity for the analyte and include inorganic or organic ligands; inorganic or organic chelators; proteins, including antibodies, enzymes and binding proteins; and nucleic acids. These molecules may be natural or synthetic. Examples of synthetic materials include molecularly imprinted polymers.

The types of analytes that may be detected include both liquid and gaseous materials. These include CO₂, O₂, pesticides, drugs, herbicides, anions, cations, antigens, oligonucleotides, steroids, prostaglandins and haptens. Further, the sensor element array device prepared according to the method of the present invention can indicate the pH of a sample. In addition, chemical sensors are available and can be used in the method of the present invention to detect the presence of organic molecules such as polycyclic aromatic hydrocarbons, explosives, glucose, cholesterol, amino acids, peptides, DNA and RNA. There are many more substances which can be detected, and the foregoing list is not to be considered exhaustive, but instead is merely representative.

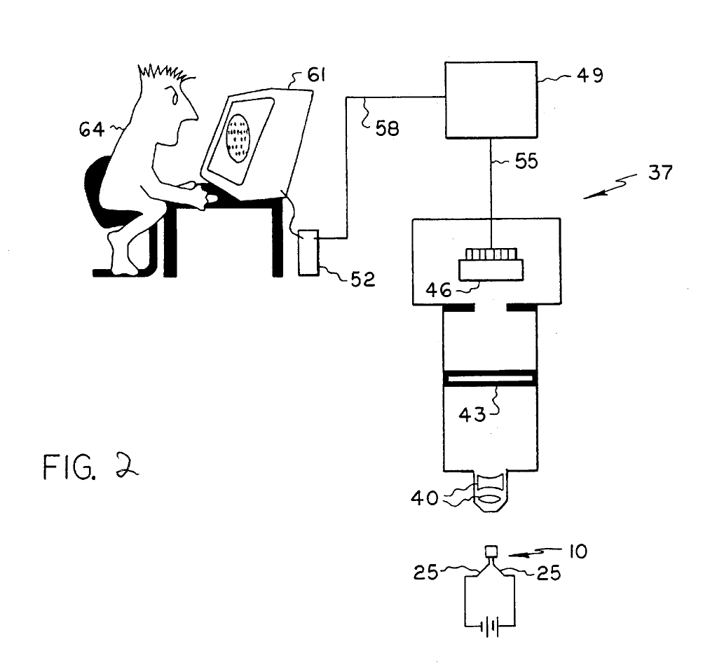

The electromagnetic radiation emitted by the chemical sensor and/or sensor element may be detected by any suitable method known in the art. A general configuration is illustrated in FIG. 2, which shows a detecting device 10 prepared according to the present invention in combination with a receiving and interpreting system 37. The receiving and interpreting system 37 has a receiver to receive electromagnetic radiation transmitted or emitted by the chemical sensor and an interpreter to interpret the received radiation. The receiver shown in FIG. 2 includes a lens or series of lenses 40, a filter or series of filters 43 and a receiving surface 46. A suitable receiver is a microscope objective. The receiver may have a camera for recording images. The interpreter includes a controller 49 and a computer 52 having software running thereon. The receiving surface 46 is connected to the controller 49 via first communication line 55. The controller 49 is connected to the computer via second line 58.

An example of a device having a series of lenses 40, is a standard inverted fluorescence microscope. An example of a microscope suitable for use in the present invention is, model number BX-FLA available from Olympus America, Inc. of Melville, N.Y.

The receiving surface 46 may be a charge coupled device, which may be part of a CCD camera. Any other optical array detector will also suffice. An example of a CCD camera which can be used in the present invention is model number TE/CCD-1317K manufactured by Princeton Instruments, Inc. of Trenton, N.J. An example of a controller 49 which is suitable for use in the present invention is model number ST-138 manufactured by Princeton Instruments.

A filter 43 may be placed between the detecting device 10 and the receiving surface 46. The filter 43 selectively passes desired wavelengths of the electromagnetic radiation moving from the detecting device 10 toward the receiving surface 46 and blocks undesired wavelengths. An example of a filter 43 which can be used to practice the present invention is model number XF 3000-38 manufactured by Omega Optical of Brattleboro, Vt. This particular filter passes electromagnetic radiation above approximately 515 nm and strongly attenuates electromagnetic radiation below approximately 515 nm. Other filters or filter combinations are possible depending on the generator wavelength and the particulars associated with a given sensor.

The following examples are presented for illustrative purposes and are not to be construed as limiting and in which the following abbreviations are used to describe certain substances:

TEOS is tetraethylorthosilane available from United Chemical Technologies of Bristol, Pa.

Pro-TriMOS is n-propyltrimethoxy silane available form Hüls America of Somerset N.J.

TMOS is tetramethoxysilane available from United Chemical Technologies of Bristol, Pa.

[Ru (ddp)₃]²⁺ is tris(4,7′-diphenyl-1,1,10′-phenantroline) ruthenium (II) ion, purified from the chloride pentahydrate salt available from GFS Chemicals of Powell, Ohio.

GOₓ is glucose oxidose type VII-S from Aspergillus niger (100-200 units mg⁻¹) available from Sigma-Aldrich of St. Louis, Mo.

PBS is phosphate buffered saline (pH 7.4).

### EXAMPLE 1

Preparation of the Sol-Gel Derived Stock Solution.

An “A” stock solution was prepared by mixing TEOS (3.345 mL, 15 mmole), distilled-deionozed water (0.54 mL, 30 mmole), EtOH(1.75 mL, 30 mmole), and HCl (15 μL of 0.1 M HCl, 15×10⁻⁴ mmole). This mixture was allowed to hydrolyze under ambient conditions for 2 hrs with stirring. A “B” stock solution was prepared by mixing Pro-TriMOS(0.5 mL, 2.84 mmole), TMOS(0.5 mL, 3.40 mmole), EtOH(1.2 mL, 20.6 mmole), and HCl (0.4 mL of 0.1 N HCl, 0.4×10⁻⁴ mmole). This mixture was hydrolyzed for 1 hr with stirring under ambient conditions.

### EXAMPLE 2

Solutions Used to Form the PPCSA Sensor Elements

The sensor elements that make up the PPCSAs were formed by doping and printing the A or B stock solutions of Example 1. A gas phase, O₂-responsive PPCSA was formed by mixing 3 μL of 34.2 mM[Ru(ddp)₃]²⁺ (dissolved in EtOH) with 500 μL of the B sol-gel stock solution of Example 1. A pH-sensitive PPCSA was formed by mixing 80 μL of 0.32 mM fluorescein-labeled dextran (dissolved in water) with 500 μL of the A sol-gel stock solution of Example 1. The O₂-responsive sensor for the dual analyte PPCSA was formed by mixing 1.5 μL of 22.5 mM[Ru(dpp)₃]²⁻(dissolved in EtOH) with 500 μL of the A sol-gel stock solution of Example 1.

### EXAMPLE 3

PPCSA Fabrication.

The sol-gel solutions of Example 2 were printed onto clean, glass microscope slides. Individual microscope slides were cleaned by soaking them in 1 M NaOH for 4 hrs. The slides were subsequently rinsed with copious amounts of distilled deionized water and dried at 80° C. The fluorophore-doped sol-gel processing solutions were printed directly onto the clean, glass microscope slides by using a ProSys 5510 system, available from Cartesian Technologies, Inc. of Irving, Calif., with a single model SMP-3 pin (TeleChem of Sunnyvale, Calif.). The print chamber relative humidity was maintained between 30 and 40%. The individual xerogel-based sensor elements were applied to the substrate on the order of 100-150 μm in diameter and were reproducible within a given PPCSA to ±10 μm. Scanning electron microscopy showed that the xerogel sensor elements were about 1-2 μm thick depending on the exact solution printed, the pin-to-substrate contact time, and the substrate's surface chemistry.

The pH- and O₂-responsive PPCSAs were printed with sensor element-to-sensor element center spacing equal to about 200 μm. Dual analyte PPCSAs were prepared by printing alternating columns of O₂-and pH-responsive sensor elements with the column-to-column center spacing adjusted to about 300 μm and the row-to-row center spacing set at about 200 μm. The time required to print each sensor element was ˜1 s.

All PPCSAs were aged under ambient conditions in the dark for at least 4 days to ensure that the xerogel was fully formed prior to being tested.

### EXAMPLE 4

Preparation of the Sol-Gel Derived Solutions for PPOSAILS Fabrication.

The solution that was used to make the actual sensor elements was prepared by mixing 50 μL of 22.5 mM[Ru(dpp)₃]²⁺ (dissolved in EtOH) with 500 μL of the B stock solution of Example 1. A xerogel base layer was used to overcoat some LEDs. This layer is prepared by using the B stock solution of Example 1.

### EXAMPLE 5

PPOSAILS Fabrication.

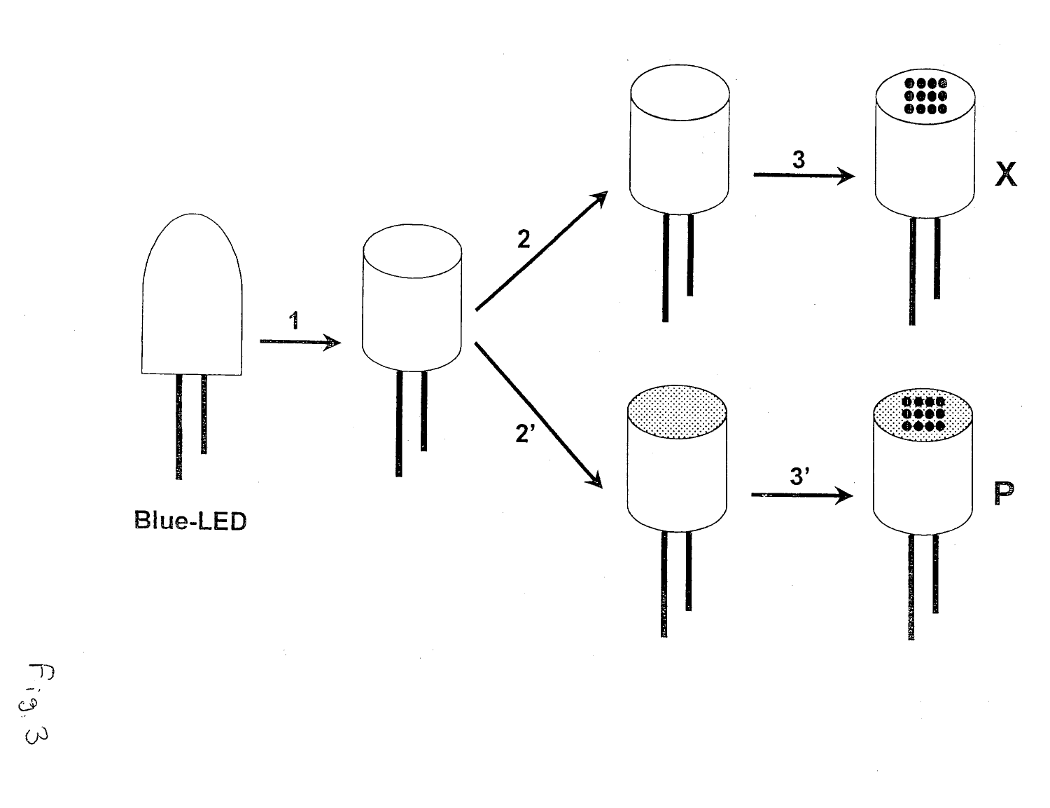

PPOSAILS were formed by following one of two divergent, three-step processes (FIG. 3). In the first step (1) the LED NSPB520S was mounted in a machinists end mill and the dome-like protective portion was removed to form a planar surface. (LEDs without the rounded envelop may be used; however, the optical output from these LEDs proved inferior in comparison to a modified LED NSPB520S.) In step (2) a thin xerogel buffer layer was deposited onto the LED face to smooth out any roughness left by the end mill and to improve the adhesion between the xerogel-based sensor elements and the LED. Toward this end, an LED was mounted in the rotor of a spin coater with the planar surface facing up, the rotor was engaged, and the rotational velocity adjusted to 3000 rpm. A 10 μL aliquot of the B stock solution of Example 1 was then delivered to the center of the rotating LED by using a micropipette and spinning was continued for 30-40 s. The xerogel buffer layer was allowed to age for 24 hrs under ambient conditions. The buffer layer final thickness was 1.1+0.1 Am. In step 2′ two coats of blue paint (Gloss, No. 1922, available from Rust-oleum® of Vernon Hills, Ill.) was sprayed onto the LED face as a buffer layer. The final thickness of this buffer layer was 120±15 μm. In the final step (3 or 3′, FIG. 3) a ProSys 5510 system (Cartesian Technologies of Irvine, Calif.) with a single model SMP-3 pin (TeleChem of Sunnyvale, Calif.) was used to print the luminophore-doped sol-gel processing solutions directly onto the xerogel base film buffer layer (3) or the paint buffer layer (3′). During the actual printing process, relative humidity within the print chamber was 35±5%. The time required to print each sensor element was ˜1 s. PPOSAILS with the xerogel or paint sub-layers are referred to as X- or P-types, respectively.

All PPOSAILS were aged under ambient conditions in the dark for at least 4 days to allow the xerogels to form.

### EXAMPLE 6

Instrumentation.

The PPOSAILS, powered by a low voltage DC power source, was mounted in a home-built flow cell holder that was positioned at the focal point of an inverted fluorescence microscope. The [Ru(dpp)₃]²⁺ molecules within the xerogel-based sensor elements are excited by the LED optical output and the resulting luminescence is collected by a 4× microscope objective, passed through a longpass optical filter (λ_{cutoff}=565 nm), and imaged on to the face of a thermoelectrically-cooled charge coupled device (CCD). When the PPOSAILS is driven at 5 V, the CCD integration time is ≦0.5 s.

All measurements were performed at room temperature. Sample introduction to the PPOSAILS was carried out by using a home-built gas handling system. The gas system used two separate inlets that are controlled by individual flow meters. Each inlet was connected to regulated N₂ or O₂ gas cylinders.

### EXAMPLE 7

PPBSA Stock Sol-Gel Processing Solutions.

Stock solution “D” was prepared by physically mixing 0.5 mL of N-propyltrimethoxy silane (Pro-TriMOS) (2.84 mmol), 0.5 mL of tetramethoxy silane (TMOS) (3.40 mmol), 1.2 mL of EtOH (20.6 mmol), and 0.4 mL of 0.1 N HCl (40 μmol). This mixture was hydrolyzed for 1 hour with stirring under ambient conditions. Stock solution “E” was prepared by physically mixing 2.25 mL of tetramethylortho silane (TEOS) (10.1 mmol), 0.7 mL of water (38.9 mmol), and 50 μL of 0.1 N HCl (5 μmol). This mixture was then sonicated (Model 75HT, VWR Scientific Products of West Chester, Pa.) under ambient conditions until the solution became clear (˜1 h). Stock solution “F” was prepared by adding 0.50 g of a Pluronic® P104 solution available form BASF of Mount Olive, N.J. (13.6% (w/v) dissolved in deionized water) to 1.00 g of solution E followed by stirring under ambient conditions for 30 min.

PEG, sorbital, and P104 are used to help produce crack-free, GOx-doped xerogels with active enzyme. We also had to contend with the issue of buffering the enzyme within the sol-gel processing solution and simultaneously avoiding gelling within the pin printer's quill pins. A wide variety of xerogel formulations and compositions were tested and screened to yield a combination of adequate working times prior to gelation, high GOx activity, sensor element uniformity, and sensor element stability. The selection of particular xerogel formulations and compositions for a particular sensor array application is within the purview of one skilled in the art.

### EXAMPLE 8

PPBSA Fabrication.

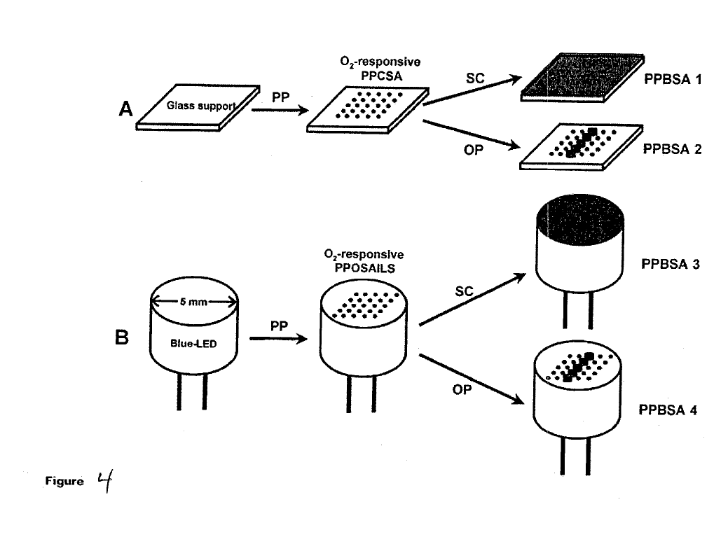

FIG. 4 presents a simplified schematic describing the four types of biosensor arrays we have fabricated. Parts A and B of FIG. 4 outline the methods of producing PPBSAs onto glass microscope slides and LEDs, respectively. The basic fabrication steps include pin printing the O₂-sensing layer (PP) and forming a glucose-sensing layer or element by spin coating (SC) or overprinting (OP), respectively.

(A) Fabrication of PPBSAs onto Planar Glass Substrates.

As shown in FIG. 4A, we initially prepared an O₂-responsive PPCSA. The O₂-sensing elements are formed from a sol-gel processing solution that is composed of 4 μL of 25.0 mM [Ru(dpp)₃)²⁺ (dissolved in EtOH) and 50 μL of solution D of Example 7. All O₂-responsive PPCSAs were aged in the dark under ambient conditions for at least 4 hours before further use. In the second step, a GOx-doped sol-gel processing solution was either spin coated (SC, PPBSA 1) or overprinted (OP, PPBSA 2) on top of the O₂-responsive PPCSAs.

To prepare the glucose-responsive layer on PPBSA 1, we prepared a GOx-doped sol-gel processing solution by mixing 10 μL of a GOx stock solution (6 mg of GOx dissolved in 500 μL of PBS) with 30 μL of solution F from Example 7. An O₂-responsive PPCSA was mounted in the rotor of a spin coater with the O₂-responsive sensing elements facing up, the rotor was engaged, and the rotational velocity was adjusted to 2000 rpm. A 10-μL aliquot of the GOx-doped sol-gel processing solution was delivered to the center of the PPCSA by using a micropipet, and spinning was continued for 10 s. Profilometry showed that the GOx-doped xerogel film was 0.5±0.1 μm thick.

To prepare PPBSA 2, we mixed the 100 μL of a GOx stock solution (6 mg of GOx, 25 mg of sorbitol, and 15 mg of PEG 400 in 500 μL of Tris buffer (5 mM, pH 7.4) with 100 μL of solution E from Example 7. The GOx-doped sol-gel processing solution was printed directly on top of the PPCSAs O₂-responsive sensor elements. Scanning electron microscopy showed that the printed glucose-responsive sensing element were 1.0±0.1 μm thick.

Fabrication of PPBSAs onto LEDs.

FIG. 4B illustrates the procedure used to form PPBSAs on LEDs. An O₂-responsive PPOSAILS was formed first. The glucose sensor elements were formed by spin coating (SC, PPBSA 3) or overprinting (OP, PPBSA 4) by using the same strategies and formulations described for PPBSA 1 and PPBSA 2, respectively.

All PPBSAs were aged in the dark for at least 24 h prior to being tested. All measurements were preformed at room temperature. All experiments were performed on at least three separate occasions using separate reagent batches. Average results from all experiments are reported along with the corresponding standard deviations.

### EXAMPLE 9

This example illustrates that devices prepared by the method of the present invention can be used to detect and quantitate analytes.

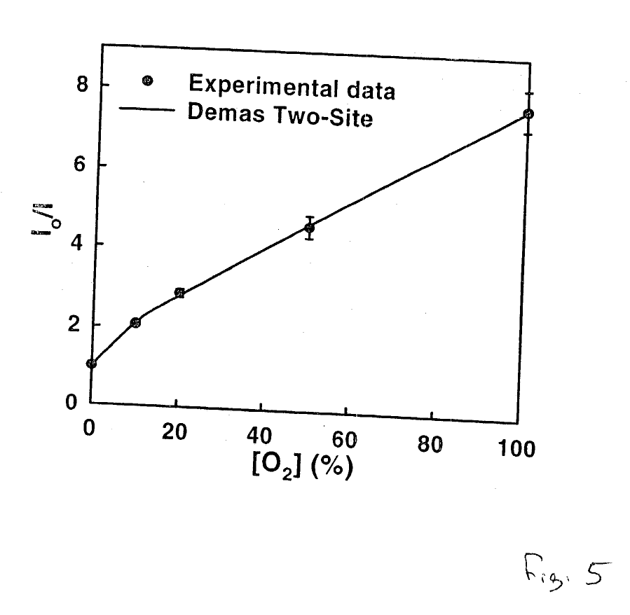

FIG. 5 represents the composite Stern-Volmer plot for the PPCSA of Example 3. The data points represent the average response from 100 individual sensor elements and the error bars reflect the 95% confidence interval associated with the 100 sensor elements. The line passing through the data points is the best fit to the Demas two-site model.

To address the issue of inter and intra sensor element to sensor element reproducibility and stability in more detail, an extensive set of tests with the O₂-responsive PPCSAs of Example 3 was performed. The results are summarized in Table 1.

TABLE 1
Pooled analytical figures of merit for an
O2-responsive PPCSA in the gas phase.

| Analytical Figure of Merit | Value |
|---|---|
| Response time^{a} | 10 ± 1 s |
| Detection limit | 0.05% O₂ |
| Absolute sensors-to-sensor response | 5% |
| reproducibility^{b} | |
| Short-term single sensor element stability^{a,c} | 3% |
| Long-term single sensor element stability^{a,d} | 6% |
| Absolute PPCSA-to-PPCSA response | 11% |
| reproducibility^{a,e} | |

^{a)}Average of 100 sensor elements on a single PPCSA ± the standard deviation.
^{b)}Based on the analysis of each PPCSA sensor element's calibration curve.
^{c)}After 3 hrs of continuous operation in a 10% O₂ environment. Laser stability is ˜2% RSD.
^{d)}Full shut down, disassemble, weekly single-sensor element recalibration and reuse of a single PPCSA for 10 weeks.
^{e)}Based on the response profiles of eight (8) separate PPSCAs fabricated at one week intervals over the course of 2 months using separate reagent batches and preparations following a single-point calibration.

These results demonstrate that reproducible and stable PPCSAs can be readily and rapidly fabricated using the method of the invention herein.

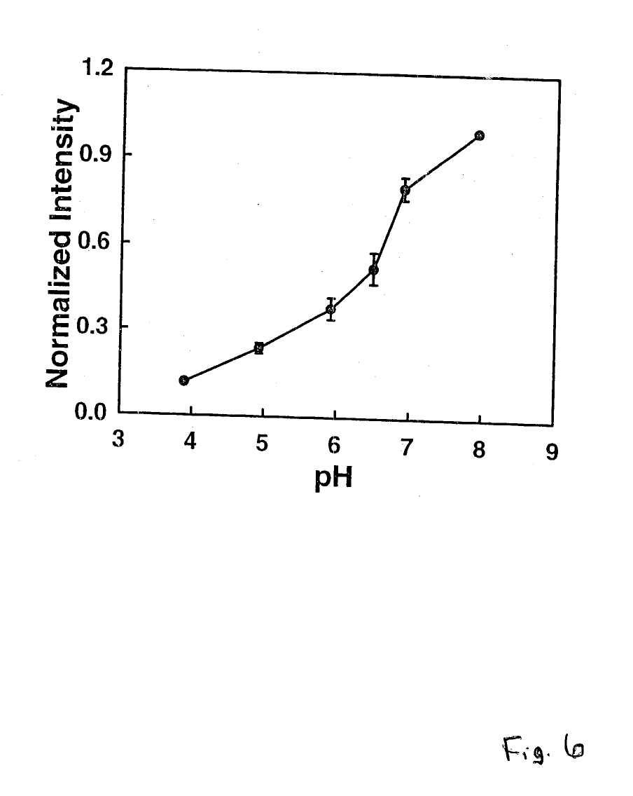

FIG. 6 represents the composite calibration curves of pH-responsive PPCSAs of Example 3. Again, the data points represent the average normalized response from 100 discrete sensor elements and-the error bars reflect the 95% confidence interval associated with the 100 sensor elements. These results demonstrate the reproducibility of the response and show that a PPCSA prepared according to the invention herein provides reproducible measurements in either the gas or solution phase.

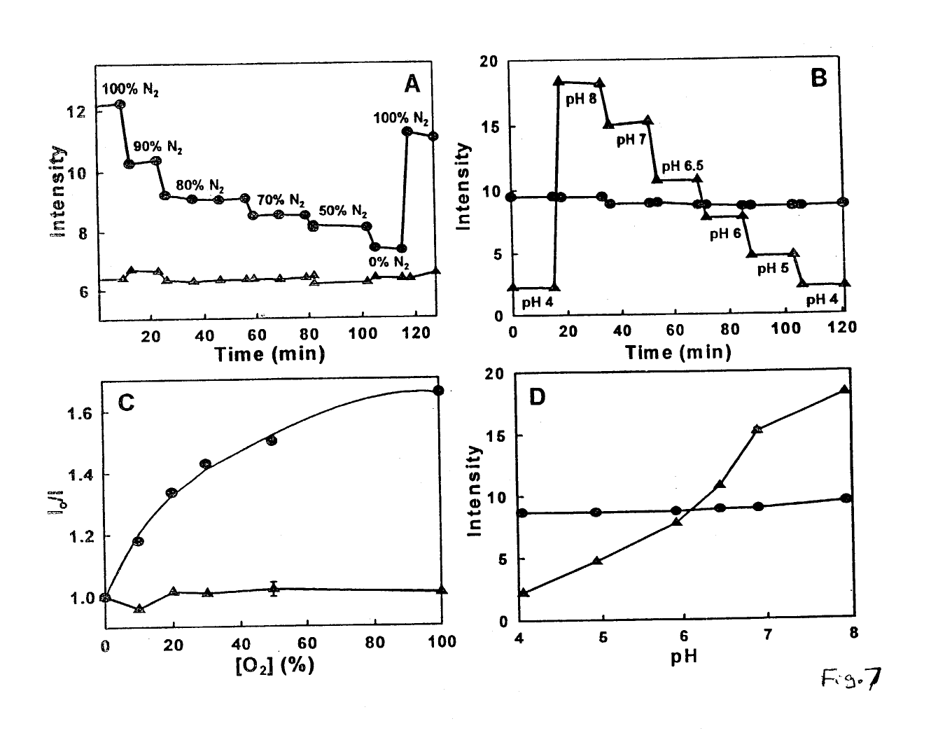

FIGS. 7 A-D summarizes the response from randomly selected O₂(●) and pH (▴) sensor elements within a dual analyte PPCSA of Example 3 to changes in solution O₂ and pH levels. FIG. 7A shows the raw response profiles from O₂ and pH sensor elements as a function of changes in the aqueous O₂ levels in distilled-deionized water. Inspection of these results shows that the O₂ sensors respond in step with changes in the O₂ level and the pH sensor response is not affected by changes in the O₂ level. FIG. 7B shows the raw response profiles from O₂ and pH sensor elements as a function of changes in the aqueous buffer pH when the solution is air saturated. These results demonstrate that the pH sensors respond only to changes in the pH and the O₂ sensor response is not affected by changes in the solution pH. FIGS. 7C and 7D represent the corresponding O₂ and pH calibration curves from the data in FIGS. 7A and 7B, respectively. No significant sensor element-to-sensor element cross talk or interference is observed. Table 2 summarizes the analytical performance of the dual analyte PPCSA of Example 3. These results show the effectiveness of PPCSA prepared according to the invention herein for simultaneous multi-analyte quantification.

TABLE 2
Pooled analytical figures of merit for the dual
analyte PPCSA in aqueous solution.

| Analytical Figure of Merit | O₂ Sensor Element | pH Sensor Element |
|---|---|---|
| Response time^{a} | 38 ± 18 s | 47 ± 8 s |
| Detection limits^{b} | 0.1% | NA |
| Resolution^{c} | NA | 0.12 pH units |
| Reversibility^{d} | 3% | 5% |
| Absolute sensors-to-sensor | 6% | 7% |
| response reproducibility | | |
| Short-term single sensor | 4% | 4% |
| element stability | | |
| Long-term single sensor | 8% | 6% |
| element stability^{a,g} | | |
| Absolute PPCSA-to-PPCSA | 12% | 10% |
| response reproducibility^{a,h} | | |

^{a)}Average of 30 sensor elements on a single PPCSA ± the standard deviation. The average of a switch between 100% O₂ and 100% N₂ or pH 4.5 and 7.5. Time is defined as the average time required to reach 90% of the full response.
^{b)}Minimum quantity of O₂ that can be detected.
^{c)}Ph resolution at pH 6.5.
^{d)}Results of 25 cycles between 100% O₂, and 100% N₂ or pH 4.0 and 8.0.
^{e)}Based on the analysis of each PPCSA sensor element's calibration curve.
^{f)}After 3 hrs of continuous operation in air-saturated buffer at pH 6.52. Laser stability is ˜2% RSD.
^{g)}Full shut down, disassembly, weekly, single-sensor element recalibration, and reuse of a single PPCSA for 6 weeks.
^{h)}Based on the response profiles of five (5) separate PPSCA fabricated at two-three week intervals over the course of 2.5 months using separate reagent batches and preparations following a single-point calibration.
NA—not applicable.

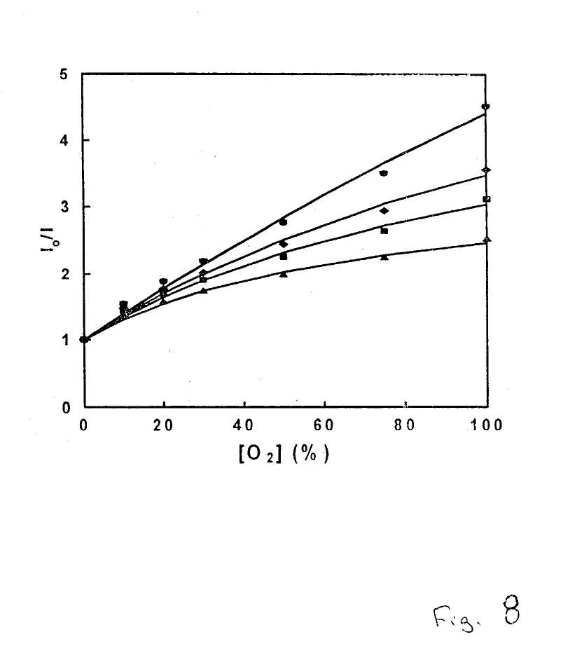

FIG. 8 represents typical Stern-Volmer plots for five randomly selected sensor elements on a X-type PPOSAILS of Example 5. The data/calibration curves do not obey the Stern-Volner relationship nor are the response curves equivalent. Thus, in an X-type PPOSAILS, one must calibrate each sensor element independently.

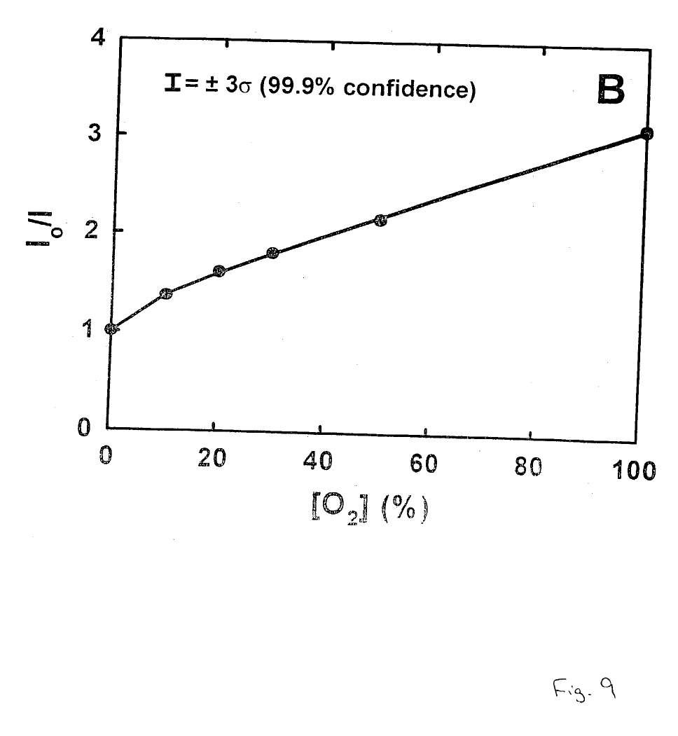

FIG. 9 summarizes the response characteristics from a typical P-type PPOSAILS prepared according to Example 5. The calibration curves for five randomly selected sensor elements in the P-type PPOSAILS are significantly more reproducible when compared to the X-type PPOSAILS (FIG. 8). A comparison of the calibration curves for the X- and P-type PPOSAILS (FIGS. 8 and 9, respectively) shows that the entire P-type PPOSAILS array can be calibrated simply by calibrating any one sensor element within the array.

The analytical performance of the P-type PPOSAILS of Example 5 is demonstrated by Table 3. These results show the potential of the P-type PPOSAILS.

TABLE 3
Pooled analytical figures of merit for an O₂-responsive
P-type PPOSAILS.

| Analytical Figure of Merit | Value |
|---|---|
| Response time^{a} | 7 ± 2 s |
| Detection limit | 0.05% O₂ |
| Absolute sensors-to-sensor response reproducibility | 2% |
| Short-term single sensor element stability^{a,c} | 4% |
| Long-term single sensor element stability^{a,d} | 6% |
| PPOSAILS-To-PPOSAILS fabrication reproducibility^{a,c} | 8% |

^{a)}Average of 100 sensor elements on a single PPOSAILS ± the standard deviation.
^{b)}Based on the analysis of 100 PPOSAILS sensor element calibration curves.
^{c)}After 12 hrs of continuous operation in a constantly cycled (100, 0, and 10% O₂) environment. The LED optical output is stable to ± 3%.
^{d)}Full shut down, weekly, single-sensor element recalibration, and reuse of a single PPOSAILS for 8 weeks.
^{e)}Based on the calibration curves for 100 sensor elements on eight (8) separate PPOSAILS fabricated at one week intervals over the course of 8 weeks using separate reagent batches and preparations following a single-point calibration.

Table 4 summarizes the analytical performance of the PPBSAs of Example 8.

TABLE 4
Pooled Analytical Figures of Merit for PPBSAs Responding to Glucose and O₂^{a}

| | | | | | response | | |
|---|---|---|---|---|---|---|---|
| | | | | | reproducibility | | |
| | | | | | (%) | | |
| | response | | | | | | PPBSA- |
| array | time | detection | | reversibility^{e} | short- | long- | to- |
| format | (s)^{b} | limits^{c} | response^{d} | (%) | term^{f} | term^{g} | PPBSA^{h} |
| PPBSA 1 | | | | | | | |
| glucose | 47 ± 17 | 0.1 mM | 29 ± 2% | 6 | 3 | 7 | 12 |
| O₂ | 12 ± 1 | 0.1% | 3.2 ± | 5 | 4 | 4 | 10 |
| | | | 0.1 | | | | |
| PPBSA 2 | | | | | | | |
| glucose | 34 ± 8 | 0.1 mM | 35 ± 3% | 5 | 3 | 8 | 12 |
| O₂ | 12 ± 2 | 0.1% | 3.5 ± 0.1 | 5 | 3 | 6 | 11 |
| PPBSA 3 | | | | | | | |
| glucose | 48 ± 14 | 0.2 mM | 17 ± 2% | 7 | 5 | 7 | 10 |
| O₂ | 10 ± 2 | 0.1% | 3.1 ± 0.1 | 5 | 4 | 5% | 9 |
| PPBSA 4 | | | | | | | |
| glucose | 35 ± 7 | 0.2 mM | 25 ± 3% | 5 | 3 | 6 | 8 |
| O₂ | 12 ± 3 | 0.1% | 3.4 ± 0.2 | 5 | 5 | 4 | 10 |

^{a)}For 100 sensor elements on a single PPBSA.
^{b)}Based on the time required to reach 90% of the full response following a switch between air-saturated buffer that contained 10 mM glucose and air-saturated buffer alone without glucose or O₂- and N_{2-saturated buffer solution. Laser stability ˜2% RSD.}
^{c)}Minimum quantity of glucose or O₂ that can be detected.
^{d)}Defined as (I − T₀)/I₀ × 100% at 4 mM glucose or I₀/I at 100% O₂. The glucose results are scaled to the actual concentration on GOx in the sensor element.
^{e)}Results of five cycles between air-saturated buffer that contained 10 mM glucose and air-saturated buffer alone without glucose or O₂- and N₂-saturated buffer solution.
^{f)}Based on the analysis of a single calibrated PPBSA after being repeatedly challenged for 12 hours with 0, 2, and 10 mM glucose solution (20% O₂) and 0, 10, and 100% O₂ saturated buffer solution (pH 7.0).
^{g)}Based on the analysis of a single calibrated PPBSA after being repeatedly challenged with 0, 2, and 10 mM glucose solution (20% O₂) and 0, 10, and 100% O₂ saturated buffer solution (pH 7.0) following full shutdown, weekly PPBSA recalibration, and reuse for 6 weeks.
^{h)}Based on the response profiles of five separate PPBSAs fabricated at 2-3-week intervals over the course of 2.5 months using separate reagent batches and preparations following complete PPBSA calibration.

Overall, the four PPBSAs of Example 8 exhibit similar analytical figures of merit. The response time and detection limits for the O₂ sensor elements were 10-12 s and 0.1% O₂, respectively. These results demonstrate that the GOx-doped xerogel-based overlayer, regardless of its composition, does not affect the performance of the underlying O₂-responsive sensor elements. The response time for the glucose sensor elements is generally a factor of 3-4 greater in comparison to the O₂ sensors, and the best-case response times are seen with the entirely pin-printed glucose sensors (i.e., PPBSA 2 and PPBSA 4). The 3-4-fold slower response is likely due to differences in the O₂ versus glucose diffusivity in water. The 25% difference in response time between PPBSA ⅓ and PPBSA 2/4 is consistent with differences in the actual xerogel composition (PPBSA ⅓: P104 and PBS; PPBSA 2/4: sorbital, PEG and Tris). (Note: The thickness of the glucose-responsive elements proper in PPBSA ⅓ and PPBSA 2/4 are 0.5 and 1.0 μm, respectively). The detection limits for glucose were between 0.1 and 0.2 mM. Detection limits for all four PPBSAs exceed clinical needs.

The response of the glucose sensor elements (scaled to the actual amount of GOx within each sensor element) was a function of the xerogel composition. In general, the spin coated glucose biosensors exhibited a response that is 30-50% poorer in comparison to the pin-printed biosensors.

When sets of PPBSAs were operated and rapidly cycled between 0 and 10 mM glucose and N₂- and O₂-saturated buffer, responses that were reproducible to within 5-7% were observed. When calibrated PPBSAs were operated over a 12-h period with regular cycling between 0, 2, and 10 mM glucose solutions (20% O₂) and 0, 10, and 100% O₂-saturated buffer solutions, the array response deviated by 3-5%. When individual PPBSAs were removed from the testing system, stored, remounted in the system, and recalibrated on a weekly basis for 6 weeks using one randomly selected biosensor element in the array, the biosensor element response deviated by no more than 4-8%. Five PPBSAs were prepared at 2-3-week intervals using different reagent batches. The sensor element responses were reproducible to within 8-12%.

Overall, these results demonstrate that the method of the invention herein provides a fast and efficient method of producing reusable chemical sensor arrays. Modifications of the invention herein may be made by one skilled in the art. For example, various shaped pins or capillary devices may be used for applying the chemical sensor elements to a substrate. Such modifications are envisioned as being within the scope and spirit of this invention as defined by the claims.

We claim:

1. A method of making a detecting device, comprising:
providing an at least translucent substrate;
providing a holding material;
providing a chemical sensor;
pin printing the holding material on the substrate; and
pin printing the chemical sensor onto the pin printed holding material.

2. The method of claim 1, wherein the step of providing the substrate comprises providing an electromagnetic radiation generating substrate.

3. The method of claim 2, wherein the step of providing an electromagnetic radiation generating substrate comprises providing a light emitting diode.

4. The method of claim 1, wherein the step of pin printing is performed by electro-mechanical means.

5. A method of making a chemical sensor array, which comprises the steps of:
a) providing at least one chemical sensor in a holding material;
b) providing an at least translucent substrate;
c) dipping at least one pin tool into the chemical sensor in the holding material;
d) withdrawing the pin tool from the chemical sensor in the holding material;
e) contacting the substrate with the pin tool withdrawn from the chemical sensor in the holding material;
f) repeating steps c)-e) until the chemical sensor array is formed; and
g) curing the chemical sensor array.

6. The method of claim 5 further comprising the step of washing the pin tool after it contacts the substrate.

7. The method of claim 5, wherein step a) comprises providing a chemical sensor in a holding material selected from the group consisting of sol-gel precursors, xerogels, aerogels, protein-doped xerogels, acrylamide gels, organic polymers, inorganic polymers, molecularly imprinted materials, and mixtures thereof.

8. The method of claim 5, wherein the chemical sensor in the holding material comprises chemical sensors selected from the group consisting of electromagnetic radiation absorbing dyes, electromagnetic radiation emitting dyes, affinity molecules, and mixtures thereof.

9. The method of claim 5, wherein step b) comprises providing a substrate selected from the group consisting of glass microscope slides, polymeric microscope slides, polymeric coated glass microscope slides, microscope slide cover slips, optical filters, mirrored slides, optical array detectors, and electromagnetic radiation generating substrates.

10. The method of claim 9, wherein the step of providing an electromagnetic radiation generating substrate comprises providing a light emitting diode.

11. The method of claim 5, wherein step c) comprises dipping a pin tool selected from the group consisting of solid pins, capillary tubes, tweezers, split pins, micro-spotting pins, and combinations thereof into the chemical sensor in the holding material.

12. The method of claim 5, wherein steps c) through e) are performed by electro-mechanical means.

13. A method of forming a sensor array and integrated light source comprising the steps of:
a) removing a protective portion of a LED to form a planar surface;
b) depositing a buffer layer on the planar surface of the LED;
c) curing the buffer layer;
d) pin printing with a pin printing tool a chemical sensor onto the buffer layer;
e) repeating step d) until the sensor array is formed; and
f) curing the sensor array.

14. The method of claim 13 further comprising the step of washing the pin printing tool after it pin prints the chemical sensor onto the buffer layer.

15. The method of claim 13 further comprising the step of applying a filtering layer to the cured buffer layer prior to the step of pin printing.

16. The method of claim 13, wherein step d) is performed by electro-mechanical means.

17. The method of claim 13 wherein step d) comprises pin printing with a pin printing tool a chemical sensor in a holding material onto the buffer layer.

18. A method of forming a pin printed biosensor array comprising the steps of:
a) providing at least one chemical sensor;
b) providing an at least translucent substrate;
c) dipping at least one pin tool into the chemical sensor;
d) withdrawing the pin tool from the chemical sensor;
e) contacting the substrate with the pin tool withdrawn from the chemical sensor;
f) repeating steps c)-e) until the chemical sensor array is formed; and
g) curing the chemical sensor array to provide a pin printed chemical sensor array; and,
h) applying a protein-doped sol-gel precursor solution onto the cured chemical sensor array to provide a pin printed biosensor array.

19. The method of claim 18 further comprising the step of washing the pin tool after it contacts the substrate.

20. The method of claim 18, wherein step a) comprises providing at least one chemical sensor in a holding material.

21. The method of claim 18, wherein step h) comprises spin coating the protein-doped sol-gel processing solution.

22. The method of claim 18, wherein step h) comprises over-printing the protein-doped sol-gel processing solution.

23. The method of claim 18, wherein steps c) through e) are performed by electro-mechanical means.

24. The method of claim 18 wherein the chemical sensor is a chemical sensor in a holding material.
